(19) United States
(12) Patent Application Publication
(10) Pub. No.: US 2024/0385934 A1
(43) Pub. Date: Nov. 21, 2024

(54) AUTOMATED MIGRATION FROM A VIRTUAL MACHINE ENVIRONMENT TO A CLOUD NATIVE ENVIRONMENT

(71) Applicant: VMWARE, INC, Palo Alto, CA (US)

(72) Inventors: VAIDEHI SAVASERE, Bangalore (IN); SRINIVAS RAJARAMAN, Palo Alto, CA (US)

(21) Appl. No.: 18/226,286

(22) Filed: Jul. 26, 2023

(30) Foreign Application Priority Data
May 16, 2023 (IN) 202341034321

(51) Int. Cl. G06F 11/14

(52) U.S. Cl. CPC G06F 11/1464; G06F 11/1451; G06F 11/1469

(57) ABSTRACT

The disclosure provides a method for migrating services from a virtual machine (VM) environment to a cloud native environment. Some embodiments include collecting first information associated with one or more first platform managers and one or more first platform control planes of the VM environment, collecting second information associated with one or more second platform managers and one or more second platform control planes of the cloud native environment, and backing up data at the VM environment associated with one or more workloads running on virtual machines in the VM environment. Some embodiments of the method include migrating the backed up data to the cloud native environment, restoring the one or more workloads as running on containers in the cloud native environment using the backed up data and registering the second IP addresses with a container control plane of the cloud native environment.

### RELATED APPLICATIONS

Benefit is claimed under 35 U.S.C. 119 (a)-(d) to Foreign application No. 202341034321 filed in India entitled “AUTOMATED MIGRATION FROM A VIRTUAL MACHINE ENVIRONMENT TO A CLOUD NATIVE ENVIRONMENT”, on May 16, 2023, by VMware, Inc., which is herein incorporated in its entirety by reference for all purposes.

### BACKGROUND

Many modern applications are designed to take advantage of the benefits of modern computing platforms and infrastructure. For example, within a data center, modern applications can be deployed onto one or more virtual machines (VMs), containers, application services, and/or the like.

Virtualization is a process whereby software is used to create an abstraction layer over computer hardware that allows the hardware elements of a single computer to be divided into multiple VMs. The software used is called a hypervisor-a small layer that enables multiple operating systems (OSs) to run alongside each other, sharing the same physical computing resources. When a hypervisor is used on a physical server (also known as a bare metal server or a host) in a data center, the hypervisor allows the physical computer to separate its SO and applications from its hardware thereby enabling the creation and management of VMs. The result is that each VM contains a guest OS, a virtual copy of the hardware that the OS requires to run, and an application and its associated libraries and dependencies.

While virtualization enables running multiple OSs on the hardware of a single physical server, containerization, on the other hand, enables deploying multiple applications using the same OS on a single node (e.g., VM or server). In particular, containerization is the packaging of software code with just the OS libraries and dependencies required to run the code to create a single lightweight executable, referred to as a container, which runs consistently on any infrastructure. Containers simplify delivery of distributed applications, and have become increasingly popular as organizations shift to cloud-native development and hybrid multi-cloud environments. Therefore, a container is a package that relies on virtual isolation to deploy and run applications that depend on a shared OS kernel. Containerized applications can include a collection of one or more related applications packaged into one or more containers. In some orchestration systems, a set of one or more related containers sharing storage and network resources, referred to as a pod, may be deployed as a unit of computing software. Container orchestration systems automate the lifecycle of containers, including such operations as provisioning, deployment, monitoring, scaling (up and down), networking, and load balancing.

Kubernetes® (K8S®) software is an example open-source container orchestration system that automates the deployment and operation of such containerized applications. In particular, Kubernetes may be used to create a cluster of interconnected nodes, including (1) one or more worker nodes that run the containerized applications (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine or a VM configured to run on a physical machine running a hypervisor.

Organizations may run processes (e.g., applications, services, functions, etc.) in different types of environments. For example, some organizations may run services in a VM environment. A VM environment may refer to one or more data centers in which processes are run in one or more VMs. As another example, some organizations may run services in a container environment (also referred to as a cloud-native environment). A cloud-native environment may refer to one or more data centers in which processes are run in one or more containers.

One type of organization is a telecommunications operator that provides a cellular network. A telecommunications operator may run telecommunication network functions in one or more data centers, such as in a VM environment or in a cloud-native environment. A cellular network provides wireless connectivity to moving devices and generally comprises two primary subsystems: a mobile core connected to the Internet and a radio access network (RAN) composed of cell sites. In a RAN deployment, such as a fifth-generation network technology (5G) RAN deployment, cell site network functions can be deployed as VMs or as containers.

In a VM environment, cell site network functions are referred to as virtual network functions (VNFs). VNFs are software applications that deliver network functions such as directory services, routers, firewalls, load balancers, and more, and are deployed as VMs.

In a cloud-native environment, cell site network functions are referred to as cloud-native network functions (CNFs). CNFs may deliver the same network functions as VNFs, but are instead deployed as containers (e.g., pods of containers).

In some cases, a telecommunications operator having VNFs deployed in a VM environment may choose to migrate from the VM environment to a cloud-native environment, and deploy the network functions as CNFs. Currently, no solutions exist to migrate from a VM environment to a cloud-native environment.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for migrating services from a virtual machine (VM) environment to a cloud native environment. Some embodiments include collecting first information associated with one or more first platform managers and one or more first platform control planes of the VM environment, collecting second information associated with one or more second platform managers and one or more second platform control planes of the cloud native environment, and backing up data at the VM environment associated with one or more workloads running on virtual machines in the VM environment. Some embodiments of the method include migrating the backed up data to the cloud native environment, restoring the one or more workloads as running on containers in the cloud native environment using the backed up data and registering the second IP addresses with a container control plane of the cloud native environment.

Further embodiments include one or more non-transitory computer-readable storage media comprising instructions that cause a computer system to carry out the above methods, as well as a computer system configured to carry out the above methods.

### BRIEF DESCRIPTION OF THE DRAWINGS

FIG. 1 illustrates an example telecommunications network, having at least a data center, a mobile core, and multiple cell sites.

FIG. 2 illustrates example physical and virtual components of a virtual machine (VM) based environment, according to an example embodiment of the present disclosure.

FIG. 3A illustrates example physical and virtual components of a cloud native environment for receiving migrated data from the data center of FIG. 2, according to an example of the present disclosure.

FIG. 3B illustrates an example cluster for running containerized workloads in the cloud native environment of FIG. 3A, according to an example embodiment of the present disclosure.

FIG. 4 illustrates an example bootstrapper script for facilitating migration of data from the VM environment of FIG. 2 to the cloud native environment of FIG. 3A, according to an example embodiment of the present disclosure.

FIG. 5 provides an example workflow for migrating data from a VM environment to a cloud native environment, according to an example embodiment of the present disclosure.

FIG. 6 provides another example workflow for migrating data from a VM environment to a cloud native environment, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques are provided herein for migrating processes from a VM environment to a cloud-native environment. Certain embodiments are discussed with respect to migrating telecommunications services from a VM environment to a cloud environment. However, it should be understood that the techniques herein may be applicable to migrating other suitable processes between different environments (e.g., from a VM environment to a cloud environment, from a first cloud environment to a second cloud environment, etc.). In an example, the migrated telecommunication services may include services provided by VMware Telco Cloud Platform, such as VMware Telco Cloud Automation (TCA) control plane and TCA Manager.

In some embodiments, a migration manager manages the migration of data corresponding to the processes from the VM environment to the cloud-native environment. In some embodiments, as part of migrating the data, the migration manager performs various operations including in a pre-validation stage, a backup stage, a folder mapping stage, a restore stage, a re-registry stage, and a post-validation stage.

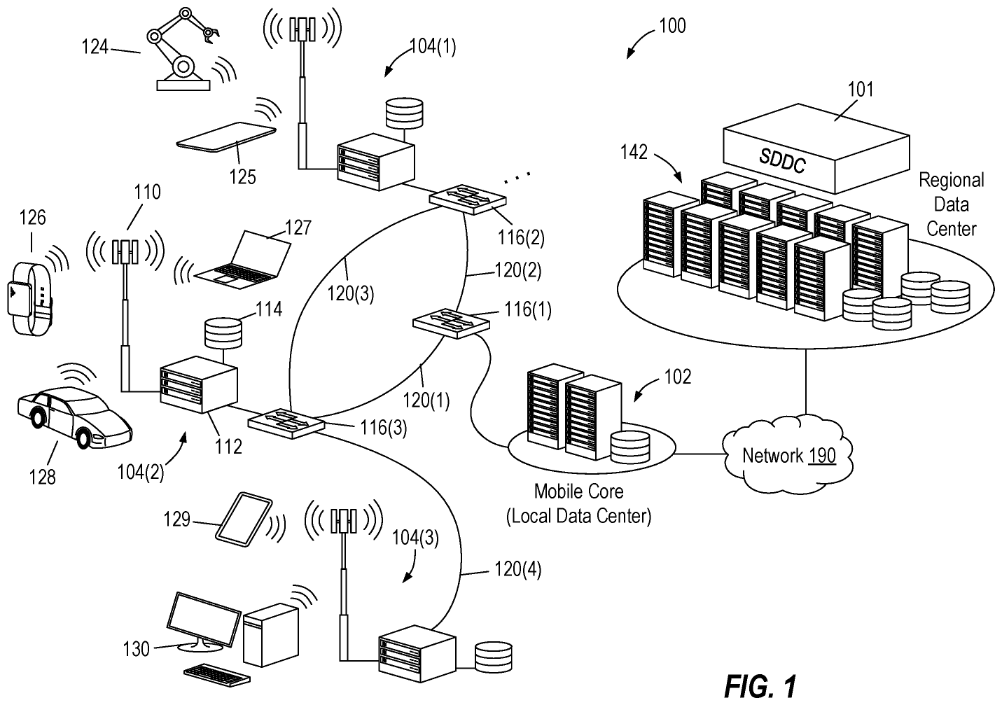

FIG. 1 illustrates an example cellular network 100. Cellular network 100 provides wireless 5G connectivity to user equipment(s) (UE(s)). UEs include mobile phones, computers, automobiles, drones, industrial and agricultural machines, robots, home appliances, and Internet-of-Things (IoT) devices. Example UEs illustrated in FIG. 1 include a robot 124, a tablet 125, a watch 126, a laptop 127, an automobile 128, a mobile phone 129, and a computer 130. To provide such 5G connectivity, cellular network 100 includes a mobile core 102, a RAN composed of cell sites, such as example cell sites 104(1)-104(3) (individually referred to herein as “cell site 104” and collectively referred to herein as “cell sites 104”), and a telecommunication cloud platform (TCP) deployed in a software-defined data center (SDDC) 101 at a regional data center (RDC) 142.

Mobile core 102 is the center of cellular network 100. Cellular network 100 includes a backhaul network that includes intermediate links, such as cables, optical fibers, and switches, and connects mobile core 102 to cell sites 104. In the example of FIG. 1, the backhaul network includes switches 116(1)-116(3) and intermediate links 120(1)-120(4). In certain embodiments, intermediate links 120 are optical fibers. In certain embodiments, the backhaul network is implemented with wireless communications between mobile core 102 and cells sites 104.

Mobile core 102 is implemented in a local data center (LDC) that provides a bundle of services. For example, mobile core 102 provides (1) internet connectivity data and voice services, (2) ensures the connectivity satisfies quality-of-service (QOS) requirements of communication service providers (CSPs), (3) tracks UE mobility to ensure uninterrupted service as users travel, and (4) tracks subscriber usage for billing and charging. Mobile core 102 provides a bridge between the RAN in a geographic area and a larger IP-based Internet.

The RAN can span dozens or even hundreds of cell sites 104. Each cell site 104 includes an antenna 110 (e.g., located on a tower), one or more computer systems 112, and a data storage appliance 114. Cells sites 104 are located at the edge of cellular network 100. Computer systems 112 at each cell site 104 run management services that maintain the radio spectrum used by the UEs and make sure the cell site 104 is used efficiently and meets QoS requirements of the UEs that communicate with the cell site. Computer systems 112 are examples of host computer systems. A host computer system is a geographically co-located server that communicates with other host computer systems in cellular network 100.

SDDC 101 is in communication with cell sites 104 and mobile core 102 through a network 190. Network 190 may be a layer 3 (L3) physical network. Network 190 may be a public network, a wide area network (WAN) such as the Internet, a direct link, a local area network (LAN), another type of network, or a combination of these.

SDDC 101 runs a telecommunications cloud platform (TCP) and a virtualization management platform (both not illustrated in FIG. 1) for managing the virtual environments of cell sites 104, and the LDC used to execute mobile core 102. The TCP uses a centralized management server to manage and customize hosts of cell sites 104 to meet cell site 5G requirements, and more specifically, high network throughout and low latency requirements.

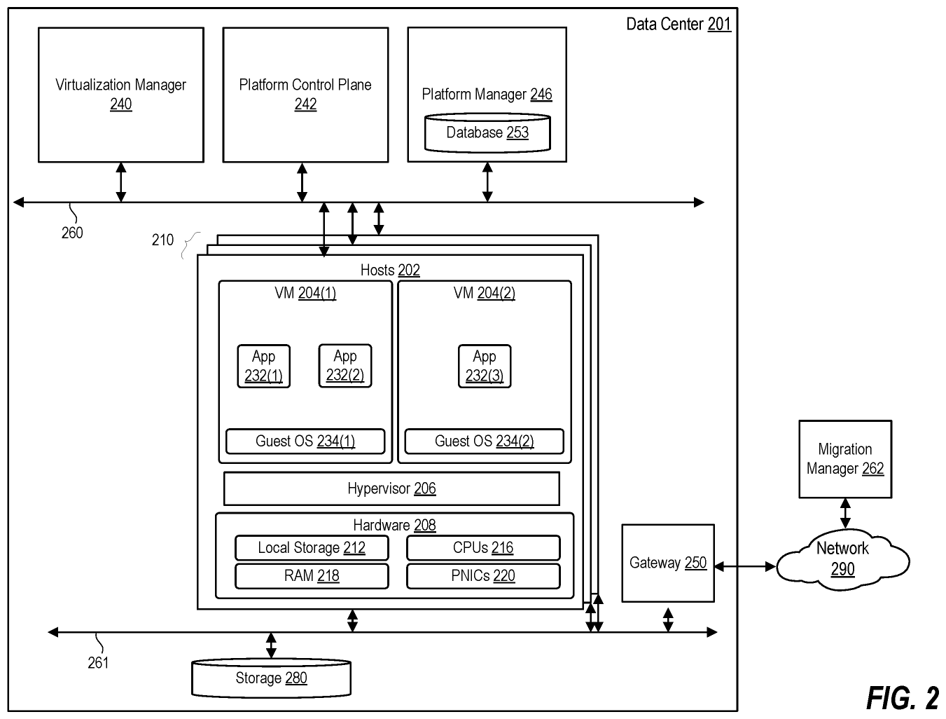

FIG. 2 illustrates example physical and virtual components of a data center. In certain aspects, data center 201 corresponds to SDDC 101 of FIG. 1. Data center 201 includes one or more hosts 202, a management network 260, a data network 261, a virtualization manager 240, a platform control plane 242, a platform manager 246, gateway 250, and storage 280.

Host(s) 202 may be communicatively connected to management network 260 and data network 261. Management network 260 and data network 261 each enables communication between hosts 202, and/or between other components and hosts 202. Management network 260 and data network 261 may be separate physical networks or may be logically isolated using a single physical network and separate virtual local area networks (VLANs) or logical overlay networks, or a combination thereof. As used herein, the term “underlay” may be synonymous with “physical” and refers to physical components of data center 201. As used herein, the term “overlay” may be used synonymously with “logical” and refers to the logical network implemented at least partially within data center 201.

Host(s) 202 may be geographically co-located servers on the same rack or on different racks in any arbitrary location in data center 201. Host(s) 202 may be in a single host cluster 210 or logically divided into a plurality of host clusters 210. Host(s) 202 may be constructed on a platform 208, which may be server grade, such as an x86 architecture platform. Hardware platform 208 of each host 202 includes components of a computing device such as one or more processors (central processing units (CPUs)) 216, memory (random access memory (RAM)) 218, one or more network interfaces (e.g., physical network interfaces (PNICs) 220), local storage 212, and other components (not shown). CPU 216 is configured to execute instructions that may be stored in memory 218, and optionally in local storage 212. The network interface(s) enable hosts 202 to communicate with other devices via a physical network, such as management network 260 and data network 261.

In certain embodiments, host(s) 202 access storage 280 using PNICs 220. In another embodiment, each host 202 contains a host bus adapter (HBA) through which input/output operations (I/Os) are sent to storage 280 over a separate network (e.g., a fibre channel (FC) network). Storage 280 may be a storage area network (SAN), network attached storage (NAS), or the like, and include one or more storage arrays. Storage 280 may include magnetic disks, solid-state disks (SSDs), flash memory, and/or the like.

In certain embodiments, storage 280 is software-based “virtual storage area network” (VSAN) that aggregates the commodity local storage 212 housed in or directly attached to hosts 202 of a host cluster 210. The VSAN provides an aggregate object store to VMs 204 running on hosts 202. Local storage 212 housed in hosts 202 may include combinations of solid state drives (SSDs) or non-volatile memory express (NVMe) drives, magnetic disks (MDs) or spinning disks or slower/cheaper SSDs, or other types of storages.

Each host 202 may be configured to provide a virtualization layer, also referred to as a hypervisor 206, that abstracts processor, memory, storage, and networking resources of hardware platform 208 of each host 202 into multiple virtual machines (VMs) 204 that run concurrently on the same host 202, such as VM 2041 and VM 2042 running on host 202 in FIG. 2. In certain embodiments, hypervisor 206 runs in conjunction with an operating system (not shown) in host 202. In some embodiments, hypervisor 206 can be installed as system level software directly on hardware platform 208 of host 202 (often referred to as “bare metal” installation) and be conceptually interposed between the physical hardware and the guest operating systems executing in the VMs 204. It is noted that the term “operating system,” as used herein, may refer to a hypervisor. One example of hypervisor 206 that may be configured and used in embodiments described herein is a VMware ESXi™ hypervisor provided as part of the VMware vSphere® solution made commercially available by VMware, Inc. of Palo Alto, CA.

Further, each of VMs 204 implements a virtual hardware platform that supports the installation of a guest OS 234 which is capable of executing one or more applications 232. Guest OS 234 may be a standard, commodity operating system. Examples of a guest OS 234 include Microsoft Windows, Linux, and/or the like. Applications 232 may be any software program, such as a VNF.

Virtualization manager 240 may be used to manage each of the clusters 210 of hosts 202. For example, the virtualization manager 240 may be configured to carry out administrative tasks for data center 201, including managing the hosts 202, grouping the hosts 202 into one or more host clusters 210, managing (e.g., configuring, starting, stopping, suspending, etc.) the VMs 204 running within each host 202, provisioning the VMs 204, transferring the VMs 204 from one host to another host, transferring application instances between the VMs 204, and/or load balancing the VMs 204 among the hosts 202 within each host cluster 210. The virtualization manager 240 may be a computer program that resides and executes in one or more central servers, which may reside inside or outside the data center 201, or alternatively, may run as one or more VMs 204 in one or more hosts 202 inside or outside the data center 201. One example of a virtualization manager is the vCenter Server® product made commercially available by VMware, Inc. of Palo Alto, California. While only one virtualization management platform 240 is shown in FIG. 2, data center 201 can include multiple virtualization management platforms 240, each managing one or more host clusters 210.

Data center 201 further includes one or more gateways 250. Gateway 250 may provide hosts 202, VMs 204, and other components in data center 201 with connectivity to one or more networks used to communicate with one or more remote datacenters and/or other devices/servers, such as secondary datacenter, etc., for example, through network 290. Network 290 may be, for example, a direct link, a local area network (LAN), a wide area network (WAN), such as the Internet, another type of network, or a combination of one or more of these networks. Gateway 250 may manage external public Internet Protocol (IP) addresses for VMs 204 and route traffic incoming to and outgoing from data center 201 and provide networking services, such as firewalls, network address translation (NAT), dynamic host configuration protocol (DHCP), and load balancing. Gateway 250 may use data network 261 to transmit data network packets to hosts 202. Gateway 250 may be a virtual appliance, a physical device, or a software module running within host 202.

Data center 201 further includes a platform manager 246 and a platform control plane 242. Platform manager 246 may run directly on a physical machine, such as host 202, or in a VM 204. Similarly, platform control plane 242 may run directly on a physical machine, such as host 202, or in a VM 204. In certain aspects, platform manager 246 and platform control plane 242 run on the same host 202. In certain aspects, platform manager 246 and platform control plane 242 run on the same VM 204. Platform manager 246 may be a TCP manager, such as TCA manager. Platform control plane 242 may be a TCP control plane, such as TCA control plane. For example, the platform manager 246 may be an orchestrator configured to orchestrate and manage workloads (e.g., VNFs) on VMs 204 in data center 201. Further, platform control plane 242 provides infrastructure abstraction for placing workloads on VMs 204.

For example, platform manager 246 may be configured to receive configuration input from, for example, an administrator indicating a deployment of workloads. The platform manager 246 may generate desired state data that specifies how the workloads should be implemented in infrastructure. The platform control 242, based on the desired state data, may instantiate VMs 204 and/or place VNFs in VMs 204 through interaction with virtualization manager 240. For example, platform control plane 242 registers with virtualization manager 240. In cases where data center 201 includes more than one virtualization manager 240, there may be additional platform control planes 242, as well.

In certain embodiments, platform manager 246 is configured to maintain a database 253 that includes management information regarding VNFs running in data center 201, such as certificates used for secure communications (e.g., by the VNFs), configuration files (e.g., for the VNFs), network files (e.g., indicating network topology for the VNFs), audit logs, application data (e.g., for the VNFs), state information (e.g., for the VNFs), and/or the like. For example, the database 253 may include information about virtual and physical objects managed by platform manager 246.

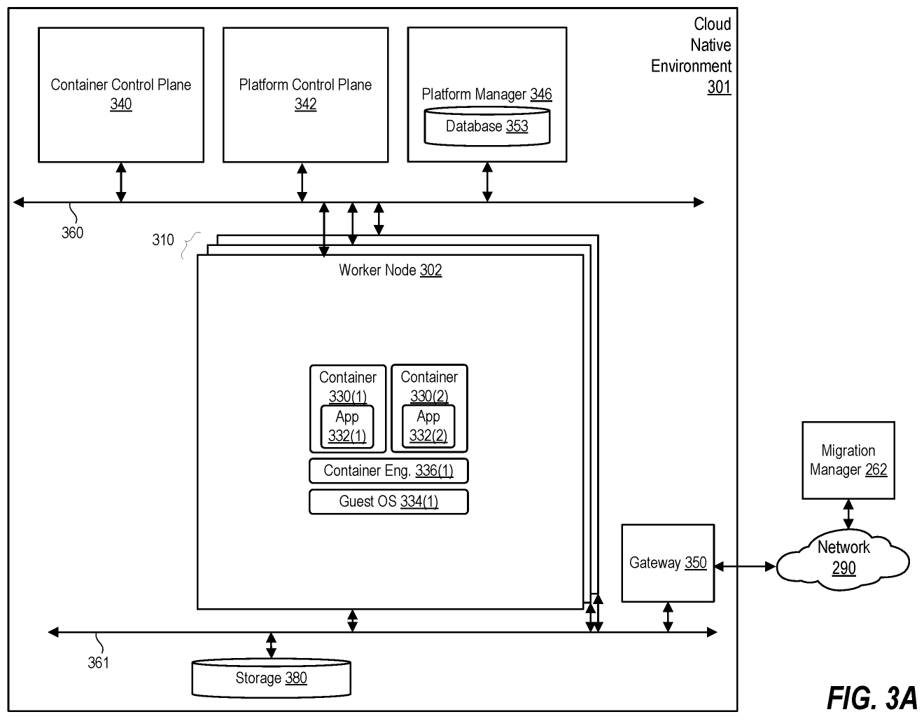

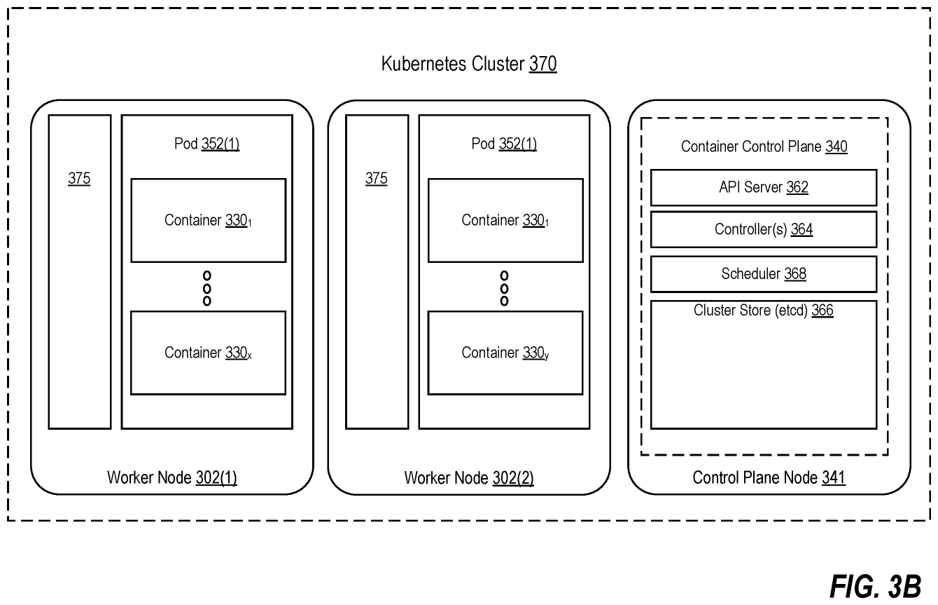

Migration manager 262 may be configured to migrate data from the VM-based environment of FIG. 2 to the containerized environment of FIG. 3A. For example, migration manager 262 may migrate data stored in database 253. Migration manager 262 may run directly on a physical machine, or in any suitable virtual computing instance, such as a VM, one or more containers, or other computing system. Migration manager 262 may run a bootstrapper script to migrate the data. Migration manager 262 is shown outside of data center 201 and is communicatively coupled to data center 201 via network 290. In certain embodiments, migration manager 262 may be in the containerized environment of FIG. 3A, or in a separate environment. Though not shown, in certain embodiments, migration manager 262 may be in data center 201.

FIG. 3A illustrates example physical and virtual components of a cloud native environment for receiving migrated data from the data center of FIG. 2, according to an example of the present disclosure. In certain aspects, cloud native environment 301 corresponds to a containerized cloud native environment. This containerized environment may be a Kubernetes® environment, but this description may be applied to other containerized cloud-based environments as well. Cloud native environment 301 includes one or more worker nodes 302, a management network 360, a data network 361, a container control plane 340, a platform control plane 342, a platform manager 346, gateway 350, and storage 380.

Each of platform control plane 342, platform manager 346, database 353, gateway 350, management network 360, data network 361, and storage 380 may be similar in function to platform control plane 242, platform manager 246, database 253, gateway 250, management network 260, data network 261, and storage 280, respectively, of FIG. 2. In certain embodiments, platform control plane 342 and platform manager 346 may instead run in one or more containers. Worker nodes 302 may be VMs or hosts, such as similar to VMs 204 or hosts 202 of FIG. 2.

Worker nodes 302 may include one or more containers 330(1), 330(2), which run one or more applications 332(1), 332(2). Applications 332 may be CNFs.

In certain embodiments, each worker node 302 includes a container engine 336 installed therein and running as a guest application under control of guest OS 334. Container engine 336 is a process that enables the deployment and management of containers 330 by providing a layer of OS-level virtualization on guest OS 334 within worker node 302. That is, with containerization, the kernel of guest OS 334 is configured to provide multiple isolated user space instances, referred to as containers. Containers 330 appear as unique servers from the standpoint of an end user that communicates with each of containers 330. However, from the standpoint of the OS on which the containers execute, the containers 330 are user processes that are scheduled and dispatched by the OS.

Container control plane 340 is an orchestration control plane, such as Kubernetes, configured to deploy and manage worker nodes 302 directly using containers 330. For example, Kubernetes may deploy containerized applications, as containers 330 and a control plane on a cluster of nodes. Container control plane 340 supports the deployment and management of applications on the cluster of nodes using containers 330. In some cases, the container control plane 340 deploys applications as pods of containers running on nodes. Though certain aspects are described herein with respect to Kubernetes, including terminology used in Kubernetes, the techniques herein are similarly applicable to other container orchestration platforms.

In certain aspects, platform control plane 342 is configured to register with container control plane 340, similar to how platform control plane 242 of FIG. 2 registers with virtualization manager 240. Accordingly, platform manager 346 may be configured to receive configuration input from, for example, an administrator indicating a deployment of workloads (e.g., CNFs). The platform manager 346 may generate desired state data that specifies how the workloads should be implemented in infrastructure. The platform control 342, based on the desired state data, may deploy containers 330 running CNFs through interaction with container control plane 340.

An example container-based cluster for running containerized applications 332 (e.g., CNFs) is illustrated in FIG. 3B. While the example container-based cluster shown in FIG. 3B is a Kubernetes cluster 370, in other examples, the container-based cluster may be another type of container-based cluster based on container technology, such as Docker Swarm clusters. As illustrated in FIG. 3B, Kubernetes cluster 370 is formed from a cluster of interconnected nodes, including (1) one or more worker nodes 302(1), 302(2), 302(3) that run one or more pods 352(1), 352(2) having containers 330(1), . . . , 330(x) and (2) one or more control plane nodes 341 having control plane 340 components running thereon that control the cluster.

Each worker node 302(1), 302(2) includes a kubelet 375. Kubelet 375 is an agent that helps to ensure that one or more pods 352 run on each worker node 302 according to a defined state for the pods 352, such as defined in a configuration file. Each pod 352 may include one or more containers 330. The worker nodes 302 can be used to execute various applications and software processes (e.g., CNFs) using containers 330. Further, each worker node 302 may include a kube proxy (not illustrated in FIG. 3B). A kube proxy is a network proxy used to maintain network rules. These network rules allow for network communication with pods 352 from network sessions inside and/or outside of Kubernetes cluster 370.

Container control plane 340 (e.g., running on one or more control plane nodes 341) includes components such as an application programming interface (API) server 362, controller(s) 364, a cluster store (etcd) 366, and scheduler(s) 368. Components of container control plane 340 make global decisions about Kubernetes cluster 370 (e.g., scheduling), as well as detect and respond to cluster events.

API server 362 operates as a gateway to Kubernetes cluster 370. As such, a command line interface, web user interface, users, and/or services communicate with Kubernetes cluster 370 through API server 362. One example of a Kubernetes API server 362 is kube-apiserver. The kube-apiserver is designed to scale horizontally. That is, this component scales by deploying more instances. Several instances of kube-apiserver may be run, and traffic may be balanced between those instances.

Controller(s) 364 is responsible for running and managing controller processes in Kubernetes cluster 370. Container control plane 340 may have multiple (e.g., four) control loops called controller processes that watch the state of Kubernetes cluster 370 and try to modify the current state of Kubernetes cluster 370 to match an intended state of Kubernetes cluster 370.

Scheduler(s) 368 is configured to allocate new pods 352 to worker nodes 372. Cluster store (etcd) 366 is a data store, such as a consistent and highly-available key value store, used as a backing store for Kubernetes cluster 370 data. In certain embodiments, cluster store (etcd) 366 stores configuration file(s), such as JavaScript Object Notation (JSON) or YAML files, made up of one or more manifests that declare intended system infrastructure and workloads to be deployed in Kubernetes cluster 370. Kubernetes objects, or persistent entities, can be created, updated and deleted based on configuration file(s) to represent the state of Kubernetes cluster 370.

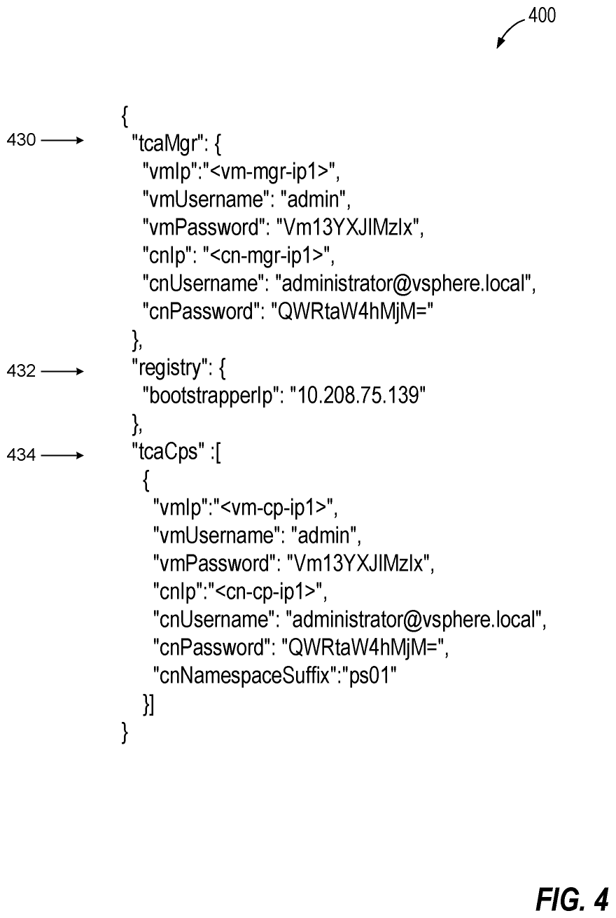

An example bootstrapper script 400 is provided in FIG. 4. In section 430, bootstrapper script 400 indicates that the platform manager 246 from FIG. 2 (VM environment) has an internet protocol (IP) address of <vm-mgr-ip1> and that IP address maps to platform manager 346 in the cloud-native environment of FIG. 3A, with an IP address of <cn-mgr-ip1>. Section 430 also maps a userID and password for the platform manager 246 (“admin” and “Vm13YXJIMzlx”) to the userID and password of platform manager 346 (“administrator@vsphere.local” and “QWRtzW4hMjM”).

In section 432, bootstrapper script 400 indicates an IP address of migration manager 262. In section 434, bootstrapper script 400 indicates that platform control plane 242 (FIG. 2) has an IP address of <vm-cp-ip1>, a userID of “admin,” and a password of “Vm13YXJIMzlx”, all of which map to platform control plane 342 (FIG. 3), which has an IP address of <cn-cp-ip1>, a userID of (“administrator@vsphere.local” and a password of “QWRtzW4hMjM”.

It should be understood that some embodiments are configured for a user to input the IP addresses, userIDs, and passwords into the bootrsrapper script 400 for facilitating this migration. It should also be understood that other embodiments may have a plurality of container control planes 340, a plurality of platform control planes 342, and/or a plurality of platform managers 346, which may each be provided in the bootstrapper script 400.

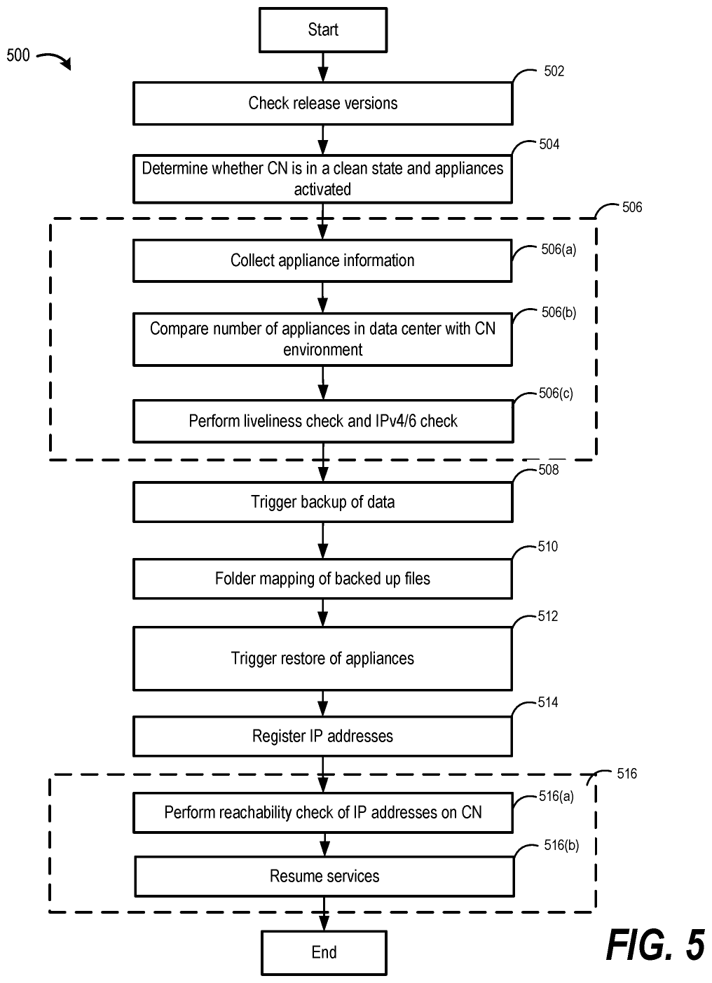

FIG. 5 illustrates example operations 500 performed to migrate data from the data center 201 of FIG. 2 to the cloud native environment 301 of FIG. 3. In certain aspects, operations 500 are performed by migration manager 262. At operation 502, migration manager 262 checks whether the same release version of the platform control plane and platform manager are running in the data center 201 and the cloud native environment 301. For example, migration manager 262 queries the release version number of platform control plane 342, platform manager 346, platform control plane 242, and platform manager 246, respectively. Further, migration manager 262 checks whether the release version number of platform control plane 342 is the same as the release version number of platform control plane 242. If they are not the same, migration manager 262 may notify a user to update, or automatically update, one or more of platform control plane 342 or platform control plane 242 to the release version number of the other. Similarly, migration manager 262 check whether the release version number of platform manager 346 is the same as the release version number of platform manager 246. If they are not the same, migration manager 262 may notify a user to update, or automatically update, one or more of platform manager 346 or platform manager 246 to the release version number of the other.

At operation 504, migration manager 262 determines whether cloud native environment 301 is in a clean state and the platform control plane 342 and platform manager 346 are activated. A clean state may refer to a default configuration prior to customization of cloud native environment 301. For example, ensuring cloud native environment 301 is in a clean state may help ensure that there are no components currently running on cloud native environment 301 that would conflict with components being migrated from data center 201. In certain aspects, if it is determined cloud native environment 301 is not in a clean state, migration manager 262 may notify a user to reset, or automatically reset, cloud native environment 301 to a clean state. If one or more of platform control plane 342 and platform manager 346 are not activated, migration manager 262 may notify a user to activate, or automatically activate, platform control plane 342 and/or platform manager 346.

A pre-validation stage 506 may include operations 506 (a), 506 (b), and 506 (c). At operation 506 (a), migration manager 262 collects information, such as IP addresses, usernames, and passwords of each of the platform appliances in the data center 201 and the cloud native environment 301. Platform appliances may include platform control plane 342, platform manager 346, platform control plane 242, platform manager 246, and/or the like.

At operation 506 (b), migration manager 262 compares the number of platform appliances at the data center 201 to the number of platform appliances at the cloud native environment 301. For example, migration manager 262 determines whether a number of platform managers at data center 201 equals a number of platform managers at cloud native environment 301. Migration manager 262 determines whether a number of platform control planes at data center 201 equals a number of platform control planes at cloud native environment 301. In certain aspects, the number of such platform appliances should be equal in data center 201 and cloud native environment 301 to ensure proper migration, such as to map platform appliances in data center 201 to platform appliances in cloud native environment 301. In certain aspects, where the number of platform appliances is not equal, migration manager 262 may notify a user to instantiate or remove, or automatically instantiate or remove, platform appliances at cloud native environment 301 to equal the number of platform appliances at data center 201.

At operation 506 (c), migration manager 262 performs a liveliness check of the IP addresses of the platform appliances, such as by pinging the IP addresses to see if the platform appliances respond. Migration manager 262 may further check for IPV4/6 formats for the IP addresses of the platform appliances on the data center 201 and the cloud native environment 301, such as to ensure the IP addresses are supported in each environment.

At operation 508, migration manager 262 triggers a backup of data (including data associated with platform appliances and other appliances, such as workloads (e.g., VNFs or CNFs)) at data center 201, and optionally cloud native environment 301. Data at data center 201 may be backed up to migrate to cloud native environment 301. Data at cloud native environment 301 may be backed up to restore cloud native environment 301 to a working state in case of any error during migration. In certain aspects, data backed up includes data stored in databases 253 and 353. The data may include, for example, certificates, configuration files, network files, audit logs data, etc. The actual backup may be performed by platform control plane 342 and/or platform manager 346 for cloud native environment 301, and platform control plane 242 and/or platform manager 246 for data center 201.

At operation 510, migration manager 262 maps folders of data backed up at data center 201 to corresponding folders at cloud native environment 301. For example, each of platform control plane 242 and platform control plane 342 may store data in the same type of folder structure/hierarchy. Accordingly, migration manager 262 moves data backed up from each folder storing data for platform control plane 242 to the corresponding folder for platform control plane 342. Similarly, each of platform manager 246 and platform manager 346 may store data in the same type of folder structure/hierarchy. Accordingly, migration manager 262 moves data backed up from each folder storing data for platform manager 246 to the corresponding folder for platform manager 346. Migration manager 262 may utilize the bootstrapper script 400 to determine location and destination of the migrated data.

At operation 512, migration manager 262 triggers restore of appliances (e.g., platform appliances and/or other appliances (e.g., workloads)) at cloud native environment 301 using the backed up data. The actual restore may be performed by platform control plane 342 and/or platform manager 346 for cloud native environment 301. For example, platform control plane 342 and/or platform manager 346 may cause the appliances to run in cloud native environment 301, such as in conjunction with container control plane 340. For example, the backed up data may include configuration files that platform control plane 342 and/or platform manager 346 may store in cluster store 366, which causes container control plane 340 to configure and run the appliances according to the configuration files. In certain aspects, migration manager 262 may cause the platform manager 246 to communicate data being migrated from database 253 to database 353.

At operation 514, migration manager 262 registers IP addresses of the platform appliances of cloud native environment 301 with the container control plane 340 so that appliances running in cloud native environment 301 use the new IP addresses of platform appliances to communicate with the platform appliances in cloud native environment 301. In particular, the IP addresses of the platform appliances in data center 201 may be different than the IP addresses of the platform appliances in cloud native environment 301. After initial migration of appliances from data center 201 to cloud native environment 301, the appliances may be configured to use the IP addresses of the platform appliances in data center 201 to communicate with the platform appliances, which means they are not reachable. Registering the IP addresses of the platform appliances of cloud native environment 301 with the container control plane 340, causes container control plane 340 to update tables of the appliances in cloud native environment 301 with the IP addresses of the platform appliances in cloud native environment 301. Accordingly, the appliances in cloud native environment 301 may be configured to use the IP addresses of the platform appliances in cloud native environment 301 to communicate with the platform appliances. The migration manager 262 may use the IP addresses identified in the bootstrapper script 400 (FIG. 4) to perform the registration.

Post-validation stage 516 includes operation 516 (a) and operation 516 (b). At operation 516 (a), migration manager 262 performs a reachability check of the IP addresses of the appliances running in cloud native environment 301, such as by pinging the IP addresses to see if the appliances respond. If the IP addresses are reachable, the migration and registration were successful. At operation 516 (b), migration manager 262 resumes the services at the cloud native environment 301.

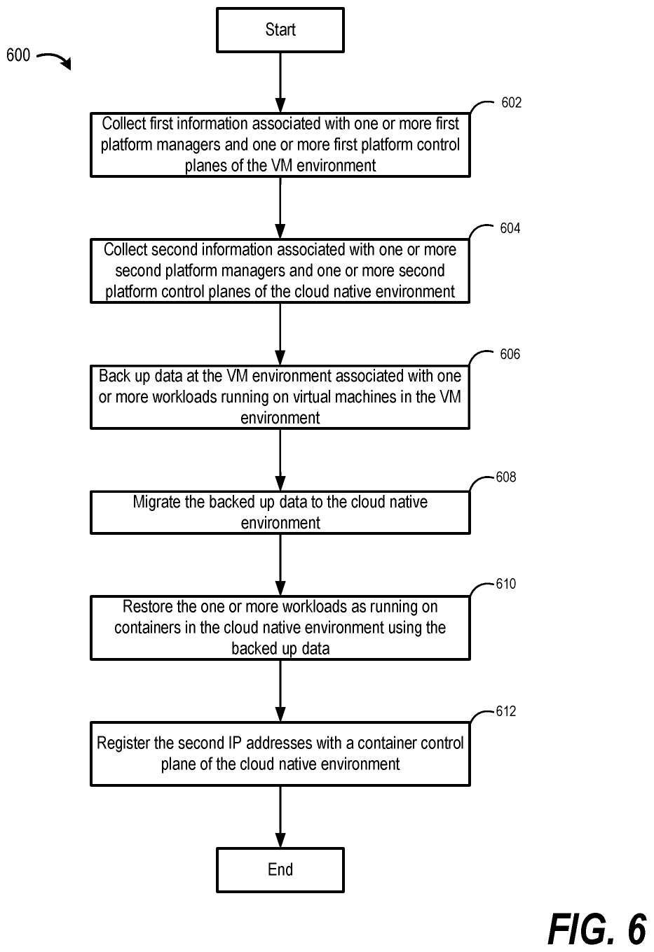

FIG. 6 provides another example workflow for migrating data from a VM based environment to a cloud environment, according to an example embodiment of the present disclosure. At operation 602, first information associated with one or more first platform managers and one or more first platform control planes of the VM environment may be collected, such as via the migration manager 262. The first information may include first IP addresses of virtual machines running the one or more first platform managers and one or more first platform control planes. At operation 604, second information associated with one or more second platform managers and one or more second platform control planes of the cloud native environment may be collected. The second information may include second IP addresses of containers running the one or more second platform managers and one or more second platform control planes.

At operation 606, data at the VM environment associated with one or more workloads running on virtual machines in the VM environment may be backed up. At operation 608, the backed up data may be migrated to the cloud native environment. At block 610, the one or more workloads as running on containers may be restored in the cloud native environment using the backed up data. At operation 612, the second IP addresses may be registered with a container control plane of the cloud native environment.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for migrating services from a virtual machine (VM) environment to a cloud native environment, comprising:
collecting first information associated with one or more first platform managers and one or more first platform control planes of the VM environment, the first information comprising first internet protocol (IP) addresses of virtual machines running the one or more first platform managers and one or more first platform control planes;
collecting second information associated with one or more second platform managers and one or more second platform control planes of the cloud native environment, the second information comprising second IP addresses of containers running the one or more second platform managers and one or more second platform control planes;
backing up data at the VM environment associated with one or more workloads running on virtual machines in the VM environment;
migrating the backed up data to the cloud native environment;
restoring the one or more workloads as running on containers in the cloud native environment using the backed up data; and
registering the second IP addresses with a container control plane of the cloud native environment.

2. The method of claim 1, wherein migrating the backed up data comprises mapping data stored in folders of the VM environment to corresponding folders of the cloud native environment.

3. The method of claim 1, further comprising determining that a number of the one or more first platform control planes equals a number of the one or more second platform control planes and that a number of the one or more first platform managers equals a number of the one or more second platform managers.

4. The method of claim 1, wherein the data comprises one or more of: certificates, configuration files, network files, or audit logs data.

5. The method of claim 1, further comprising, after the registering, checking the second IP addresses are reachable.

6. The method of claim 1, further comprising determining a version of the one or more first platform managers is the same as a version of the one or more second platform managers.

7. The method of claim 1, further comprising backing up data at the cloud native environment.

8. A system for migrating services from a virtual machine (VM) environment to a cloud native environment, comprising:
at least one processor; and
at least one memory, the at least one processor and the at least one memory configured to:
collect first information associated with one or more first platform managers and one or more first platform control planes of the VM environment, the first information comprising first internet protocol (IP) addresses of virtual machines running the one or more first platform managers and one or more first platform control planes;
collect second information associated with one or more second platform managers and one or more second platform control planes of the cloud native environment, the second information comprising second IP addresses of containers running the one or more second platform managers and one or more second platform control planes;
back up data at the VM environment associated with one or more workloads running on virtual machines in the VM environment;
migrate the backed up data to the cloud native environment;
restore the one or more workloads as running on containers in the cloud native environment using the backed up data; and
register the second IP addresses with a container control plane of the cloud native environment.

9. The system of claim 8, wherein migrating the backed up data comprises mapping data stored in folders of the VM environment to corresponding folders of the cloud native environment.

10. The system of claim 8, wherein the at least one processor and the at least one memory are further configured to determine that a number of the one or more first platform control planes equals a number of the one or more second platform control planes and that a number of the one or more first platform managers equals a number of the one or more second platform managers.

11. The system of claim 8, wherein the data comprises one or more of: certificates, configuration files, network files, or audit logs data.

12. The system of claim 8, wherein the at least one processor and the at least one memory are further configured to check, after the registering, the second IP addresses are reachable.

13. The system of claim 8, wherein the at least one processor and the at least one memory are further configured to determine a version of the one or more first platform managers is the same as a version of the one or more second platform managers.

14. The system of claim 8, wherein the at least one processor and the at least one memory are further configured to back up data at the cloud native environment.

15. One or more non-transitory computer-readable storage media comprising instructions that, when executed by at least one processor of a computing system, cause the computing system to perform operations for migrating services from a virtual machine (VM) environment to a cloud native environment, comprising, the operations comprising:
collecting first information associated with one or more first platform managers and one or more first platform control planes of the VM environment, the first information comprising first internet protocol (IP) addresses of virtual machines running the one or more first platform managers and one or more first platform control planes;
collecting second information associated with one or more second platform managers and one or more second platform control planes of the cloud native environment, the second information comprising second IP addresses of containers running the one or more second platform managers and one or more second platform control planes;
backing up data at the VM environment associated with one or more workloads running on virtual machines in the VM environment;
migrating the backed up data to the cloud native environment;
restoring the one or more workloads as running on containers in the cloud native environment using the backed up data; and
registering the second IP addresses with a container control plane of the cloud native environment.

16. The one or more non-transitory computer-readable storage media of claim 15, wherein migrating the backed up data comprises mapping data stored in folders of the VM environment to corresponding folders of the cloud native environment.

17. The one or more non-transitory computer-readable storage media of claim 15, wherein the operations further comprise determining that a number of the one or more first platform control planes equals a number of the one or more second platform control planes and that a number of the one or more first platform managers equals a number of the one or more second platform managers.

18. The one or more non-transitory computer-readable storage media of claim 15, wherein the data comprises one or more of: certificates, configuration files, network files, or audit logs data.

19. The one or more non-transitory computer-readable storage media of claim 15, wherein the operations further comprise, after the registering, checking the second IP addresses are reachable.

20. The one or more non-transitory computer-readable storage media of claim 15, wherein the operations further comprise:
determining a version of the one or more first platform managers is the same as a version of the one or more second platform managers; and
backing up data at the cloud native environment.
